(19) United States
(12) Patent Application Publication
(10) Pub. No.: US 2026/0120039 A1
(43) Pub. Date: Apr. 30, 2026

(54) SALES NEGOTIATION TRAINING METHOD

(71) Applicant: TOYOTA JIDOSHA KABUSHIKI KAISHA, Toyota-shi (JP)

(72) Inventors: Koji MINAMI, Tokyo (JP); Hirofumi MORISHITA, Anjo-shi (JP)

(73) Assignee: TOYOTA JIDOSHA KABUSHIKI KAISHA, Toyota-shi (JP)

(21) Appl. No.: 19/303,945

(22) Filed: Aug. 19, 2025

(30) Foreign Application Priority Data
Oct. 30, 2024 (JP) 2024-191170

(51) Int. Cl. G06Q 10/0639; G10L 15/22; G10L 25/63

(52) U.S. Cl. CPC G06Q 10/06398; G10L 15/22; G10L 25/63

(57) ABSTRACT

A sales negotiation training method that is executed by an information processing device includes storing a plurality of personas with different levels of difficulty regarding sales negotiations, setting a persona that corresponds to one level of difficulty that is selected in the conversational AI, when the one level of difficulty is selected from among a plurality of the levels of difficulty, and starting a virtual sales negotiation dialogue with the conversational AI, to which the persona has been set, as a sales negotiation counterpart.

### CROSS-REFERENCE TO RELATED APPLICATION

This application claims priority to Japanese Patent Application No. 2024-191170 filed on Oct. 30, 2024. The disclosure of the above-identified application, including the specification, drawings, and claims, is incorporated by reference herein in its entirety.

### BACKGROUND

### 1. Technical Field

The present disclosure relates to a sales negotiation training method.

### 2. Description of Related Art

As related art, for example, Japanese Unexamined Patent Application Publication No. 2023-076413 (JP 2023-076413 A) discloses technology for generating a conversational bot specialized for a given domain based on documents in that domain, using a large language model.

### SUMMARY

JP 2023-076413 A discloses usage of a large language model, which is a type of machine learning model, to generate a conversational bot that is specialized for the domain. In the future, it is conceivable that dialogue systems such as conversational bots or the like will be used for an object of training young sales staff in sales negotiations, at vehicle dealerships and so forth. However, J P 2023-076413 A does not fully take into consideration a dialogue system that is specialized for training in sales negotiations. Accordingly, there is room for improvement in sales negotiation training technology using dialogue systems.

In view of the above circumstances, an object of the present disclosure is to improve sales negotiation training technology using a dialogue system.

A sales negotiation training method according to an embodiment of the present disclosure is executed by an information processing device, the sales negotiation training method including
storing a plurality of personas with different levels of difficulty regarding sales negotiations,
setting a persona that corresponds to one level of difficulty that is selected in a conversational AI, when the one level of difficulty is selected from among a plurality of the levels of difficulty, and
starting a virtual sales negotiation dialogue with the conversational AI, to which the persona has been set, as a sales negotiation counterpart.

According to the embodiment of the present disclosure, sales negotiation training technology using a dialogue system is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure; and

FIG. 2 is a flowchart showing operations of an information processing device.

### DETAILED DESCRIPTION OF EMBODIMENTS

An embodiment of the present disclosure will be described below.

### Outline of Embodiment

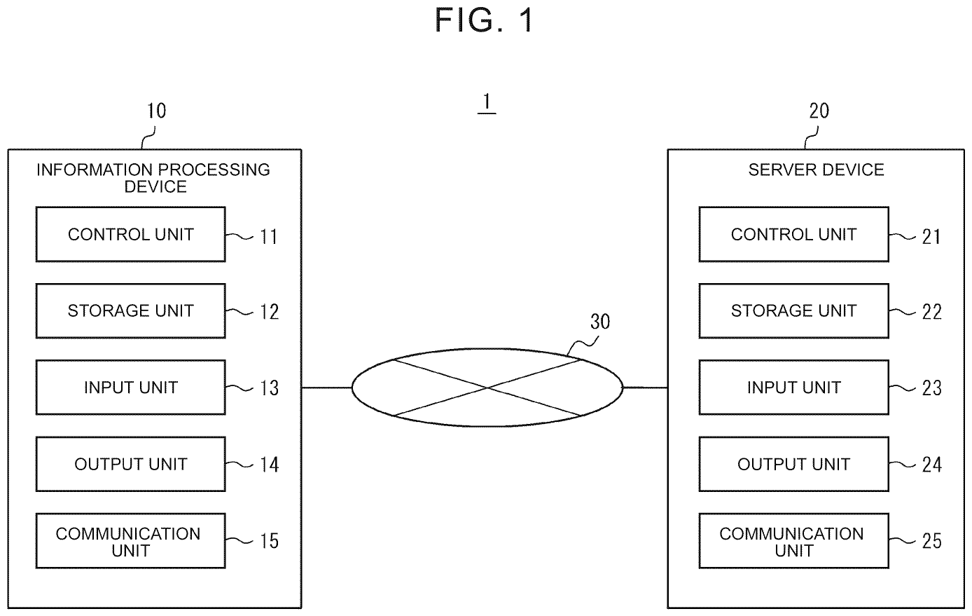

An outline and a configuration of a system 1 according to the present embodiment will be described with reference to FIG. 1. The system 1 according to the present embodiment includes an information processing device 10 and a server device 20. The information processing device 10 is any device that is used by each of users. For example, general-purpose electronic equipment such as personal computers, smartphones, tablet terminals, wearable terminals, and so forth, or dedicated electronic equipment, can be employed as the information processing device 10. The server device 20 is a server device that is installed in, for example, a data center or the like. The server device 20 is, for example, a server belonging to a cloud computing system or some other computing system. The server device 20 is equipped with a dialogue system (hereinafter also referred to as conversational AI). In the present embodiment, the conversational AI is constructed using any dialogue system, such as a large language model (LLM) a chatbot, or the like, for example. The conversational AI can perform dialogue with a user by outputting text corresponding to a prompt, based on input of the prompt. Here, a persona of the conversational AI of the server device 20 can be set by entering a prompt. Note that a persona is configuration items relating to personality, role, and so forth, that defines communication tendencies of an interlocutor. In other words, changing the configuration items related to the persona enables a single conversational AI to realize dialogues that mimic a plurality of different personalities, roles, and so forth. In the present embodiment, when a persona is set in the conversational AI, dialogue can be performed by the conversational AI in which the persona is set. The information processing device 10 and the server device 20 are communicatively connected to a network 30 including, for example, a mobile communication network, the Internet, and so forth. Note that while FIG. 1 illustrates one information processing device 10 and one server device 20, the system 1 may include a plurality of such devices.

First, the outline of the present embodiment will be described, and details will be described later. The information processing device 10 stores a plurality of personas each having a different level of difficulty in sales negotiations. When one level of difficulty is selected from among a plurality of the levels of difficulty, the information processing device 10 sets a persona corresponding to the one level of difficulty that is selected in the conversational AI. The information processing device 10 starts a virtual sales negotiation dialogue with the conversational AI, to which the persona has been set, as a sales negotiation counterpart. Note that in the present embodiment, the sales negotiation counterpart is a customer who is considering purchasing a product or a service. A virtual sales negotiation is a training negotiation that is carried out in which the sales negotiation counterpart is assumed to be considering purchasing a product or a service.

Thus, according to the present embodiment, when one level of difficulty is selected from among the levels of difficulty, a persona corresponding to the one level of difficulty that is selected is set in the conversational AI, and a virtual sales negotiation dialogue is started with the conversational AI to which the persona is set as the sales negotiation counterpart. Accordingly, sales negotiation training technology that uses the dialogue system is improved with respect to the point that changing the level of difficulty enables utilization thereof in sales negotiation training that aims for training and so forth of young sales staff at vehicle dealerships and so forth.

Next, each of the configurations of the information processing device 10 and the server device 20 will be described in detail. As illustrated in FIG. 1, the information processing device 10 includes a control unit 11, a storage unit 12, an input unit 13, an output unit 14, and a communication unit 15. The control unit 11 includes at least one processor. The processor is a general-purpose processor such as a central processing unit (CPU) or the like, or a dedicated processor that is specialized for specific processing. The control unit 11 executes processing related to operations of the information processing device 10, while controlling the units of the information processing device 10. The storage unit 12 includes at least one semiconductor memory or the like. The semiconductor memory is, for example, random access memory (RAM) or read-only memory (ROM). The storage unit 12 functions as, for example, a main storage device or an auxiliary storage device. The storage unit 12 stores data that is used for the operations of the information processing device 10 and data that is acquired through the operations of the information processing device 10. For example, the storage unit 12 stores a learning model. A learning model is a model that is created by machine learning using a machine learning algorithm. The learning model may be, for example, a machine learning model that is constructed based on a decision tree, or a model that is generated based on a machine learning algorithm such as a convolutional neural network (CNN), a recurrent neural network (RNN), or some other type of deep learning or the like. The input unit 13 includes at least one input interface. The input interface may be, for example, physical keys, a touchscreen display, a sound sensor that accepts speech input, a camera that accepts gesture input, or the like. The input unit 13 receives operations for inputting data to be used for operations of the information processing device 10. The output unit 14 includes at least one output interface. The output interface is, for example, a display that outputs information as video, a speaker that outputs information as audio, or the like. The output unit 14 outputs data obtained by the operations of the information processing device 10. The communication unit 15 includes at least one external communication interface. The communication interface may be an interface for either wired communication or wireless communication. In the case of wired communication, the communication interface is, for example, a local area network (LAN) interface or a Universal Serial Bus (USB) interface. In the case of wireless communication, the communication interface is, for example, an interface compatible with mobile communication standards such as 5G or the like, or an interface that is compatible with near-field communication. The communication unit 15 receives data that is used for the operations of the information processing device 10, and also transmits data that is acquired through the operations of the information processing device 10.

Also, as illustrated in FIG. 1, the server device 20 includes a control unit 21, a storage unit 22, an input unit 23, an output unit 24, and a communication unit 25. The control unit 21 includes at least one processor. The processor is a general-purpose processor such as a CPU or the like, or a dedicated processor that is specialized for specific processing. The control unit 21 executes processing related to the operations of the server device 20 while controlling each unit of the server device 20. The storage unit 22 includes at least one semiconductor memory or the like. The semiconductor memory is, for example, RAM or ROM. The storage unit 22 functions as, for example, a main storage device or an auxiliary storage device. The storage unit 22 stores data that is used in the operations of the server device 20 and data that is obtained by the operations of the server device 20. The input unit 23 includes at least one input interface. The input interface may be, for example, physical keys, a touchscreen display, a sound sensor that accepts speech input, a camera that accepts gesture input, or the like. The input unit 23 accepts operations for inputting data to be used for the operations of the server device 20. The output unit 24 includes at least one output interface. The output interface is, for example, a display that outputs information as video, a speaker that outputs information as audio, or the like. The output unit 24 outputs data that is obtained through the operations of the server device 20. The communication unit 25 includes at least one external communication interface. The communication interface may be an interface for either wired communication or wireless communication. In the case of wired communication, the communication interface is, for example, a LAN interface or a USB interface. In the case of wireless communication, the communication interface is, for example, an interface compatible with mobile communication standards such as 5G or the like, or an interface that is compatible with near-field communication. The communication unit 25 receives data that is used in the operations of the server device 20, and also transmits data that is obtained by the operations of the server device 20.

Functions of the information processing device 10 or the server device 20 are realized by executing a program according to the present embodiment in a processor corresponding to the control unit 11 or the control unit 21. That is to say, the functions of the information processing device 10 or the server device 20 are realized by software. The program causes a computer to execute the operations of the information processing device 10 or the server device 20, thereby causing the computer to function as the information processing device 10 or the server device 20. That is to say, the computer functions as the information processing device 10 or the server device 20 by executing the operations of the information processing device 10 or the server device 20 in accordance with the program. In the present embodiment, the program can be recorded in a computer-readable recording medium. The computer-readable recording medium includes non-transitory computer-readable media, and is, for example, magnetic recording devices, semiconductor memory, and the like. The distribution of the program is carried out by, for example, selling, transferring, or renting a portable recording medium such as a DVD or the like in which the program is recorded. Also, distribution of the program may be performed by storing the program in storage of an external server and transmitting the program from the external server to another computer. Further, the program may be provided as a program product. Part or all of the functions of the information processing device 10 or the server device 20 may be realized by a dedicated circuit corresponding to the control unit 11 or the control unit 21. That is to say, part or all of the functions of the information processing device 10 or the server device 20 may be realized by hardware.

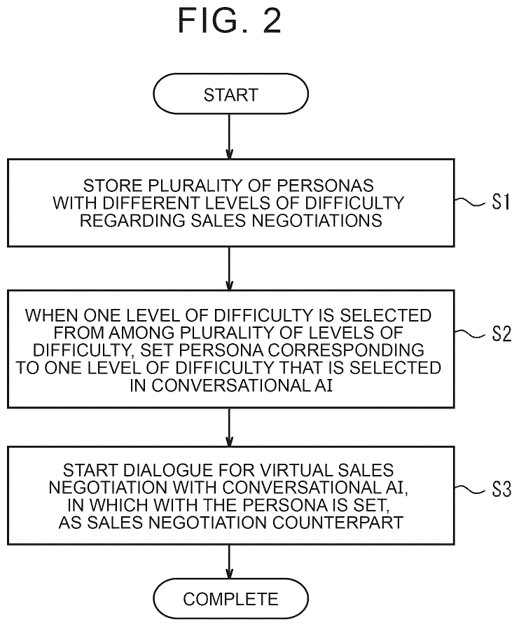

The operations of the information processing device 10 according to the present embodiment will be described with reference to FIG. 2. First, the control unit 11 of the information processing device 10 stores multiple personas with different levels of difficulty of sales negotiations (step S1). Any technique may be employed for storage processing of the personas. For example, the control unit 11 may store multiple personas in the storage unit 12. Alternatively, the control unit 11 may store multiple personas in an external device including the server device 20.

Next, when one level of difficulty is selected from among the levels of difficulty, the control unit 11 sets a persona corresponding to the one level of difficulty that is selected in the conversational AI (step S2). Any technique can be employed for the level of difficulty selection processing. For example, the control unit 11 may select one level of difficulty from among the multiple levels of difficulty based on input by a user to the input unit 13. Also, multiple levels of difficulty may be displayed and output in a selectable manner as appropriate, by a user interface via the output unit 14.

Any technique can be employed to identify a persona that corresponds to one level of difficulty that is selected. For example, a correlation table that correlates levels of difficulty with personas may be stored in the storage unit 12. The control unit 11 may reference the correlation table to identify a persona that corresponds to the one level of difficulty that is selected. Any technique can be employed in setting processing of a persona in a conversational AI. For example, the control unit 11 generates a prompt related to the setting processing and transmits the prompt to the server device 20 via the communication unit 15. The control unit 21 of the server device 20 may set a persona for the conversational AI based on the prompt.

Next, the control unit 11 starts a virtual sales negotiation dialogue with the conversational AI to which the persona has been set, as a sales negotiation counterpart (step S3). Any technique can be employed in the starting processing of the dialogue. For example, the control unit 11 transmits a request (speech or text data) for starting a dialogue to the server device 20 via the communication unit 15. The control unit 21 of the server device 20 generates a response (speech or text data) to the request using the conversational AI to which the persona is set, and transmits the response that is generated to the information processing device 10 via the communication unit 25. The control unit 11 of the information processing device 10 performs speech output or display output of the response through the output unit 14. The control unit 11 stands by for an input from the user (speech or text data) as to the response. These operations are repeated until the virtual sales negotiation dialogue ends, and thus the virtual sales negotiation with the user is performed.

As described above, the information processing device 10 according to the present embodiment stores multiple personas with different levels of difficulty for sales negotiations, and when one level of difficulty is selected from among the levels of difficulty, the persona corresponding to the one level of difficulty that is selected is set in the conversational AI. The information processing device 10 then starts a virtual sales negotiation dialogue with the conversational AI, to which the persona has been set, as a sales negotiation counterpart.

According to this configuration, when one level of difficulty is selected from among the levels of difficulty, a persona corresponding to the one level of difficulty that is selected is set in the conversational AI, and a virtual sales negotiation dialogue is started with the conversational AI to which the persona is set as the sales negotiation counterpart. Accordingly, sales negotiation training technology that uses the dialogue system is improved with respect to the point that changing the level of difficulty enables utilization thereof in sales negotiation training that aims for training and so forth of young sales staff at vehicle dealerships and so forth.

Here, as for a learning technique for the conversational AI, for each sales negotiation conducted in the past, a transcribed text of audio recording data of the sales negotiation, and data indicating the level of difficulty of the sales negotiation, are accumulated, and the transcribed text, and the data indicating the difficulty level, may be used as training data for the conversational AI. Note that the level of difficulty of a sales negotiation may be determined based on annotations or audio recording data of the sales negotiation. In other words, the level of difficulty of a sales negotiation may be set by manual annotation (such as by manual entry by the salesperson who actually performed the sales negotiation), or it may be automatically estimated from at least one of the audio recording data and text of the sales negotiation. When automatically estimating the level of difficulty of a sales negotiation, for example, the level of difficulty of the sales negotiation may be determined based on at least one of duration of the dialogue, count of times of utterance, tone of voice of the customer, and volume of voice of the customer. Specifically, for example, the longer the duration of the dialogue is, or the greater the count of times of utterance is, the higher the level of difficulty may be estimated to be. Also, for example, the rougher the tone of voice of the customer who is the sales negotiation counterpart is, or the louder the volume of the voice is, the higher the level of difficulty may be estimated to be.

Also, for example, the level of difficulty may be determined based on an estimated emotion of the customer, based on audio recording data of the sales negotiation. Specifically, for example, when a specific emotion (such as “anger”, “anxiety”, “irritation”, or the like) is estimated, using a machine learning model that estimates emotions of the customer from the content of the dialogue (audio recording data or text), the level of difficulty may be estimated to be high.

Although the present disclosure has been described above based on the drawings and the embodiment, it should be noted that those skilled in the art may make various modifications and alterations thereto based on the present disclosure. It should be noted, therefore, that such modifications and alterations are within the scope of the present disclosure. For example, the functions and so forth included in the configurations, the steps, and so forth can be rearranged so as not to be logically inconsistent, and a plurality of the configurations, steps, and so forth, can be combined into one, or can be divided.

For example, in the above-described embodiment, an embodiment can be made in which the configuration and operations of the information processing device 10 are distributed among a plurality of computers, including the server device 20, that are capable of communicating with each other.

Also, for example, in the above description, the persona is a configuration item related to personality, role, and so forth, that defines the communication tendencies of the interlocutor, but is not limited to this. For example, a persona may include attributes of the interlocutor (age, gender, family makeup, budget, hobbies and interests, occupation, place of residence, life events, and purchasing history). In other words, the configuration items that are set for the conversational AI may include the above attributes of the interlocutor, in addition to personality and role parameters.

What is claimed is:

1. A sales negotiation training method that is executed by an information processing device, the sales negotiation training method comprising:
storing a plurality of personas with different levels of difficulty regarding sales negotiations;
setting a persona that corresponds to one level of difficulty that is selected in a conversational AI, when the one level of difficulty is selected from among a plurality of the levels of difficulty; and
starting a virtual sales negotiation dialogue with the conversational AI, to which the persona was set, as a sales negotiation counterpart.

2. The sales negotiation training method according to claim 1, wherein, for each sales negotiation that was conducted in the past, transcribed text of audio recording data of the sales negotiation and data indicating the level of difficulty of the sales negotiation are accumulated and are used as training data for the conversational AI, as a learning technique for the conversational AI.

3. The sales negotiation training method according to claim 2, wherein the level of difficulty of the sales negotiation is determined based on annotations or audio recording data of the sales negotiation.

4. The sales negotiation training method according to claim 3, wherein the level of difficulty is determined based on at least one of duration of dialogue, count of times of utterance, tone of voice of a customer, and volume of voice of the customer.

5. The sales negotiation training method according to claim 3, wherein the level of difficulty is determined based on an estimated emotion of a customer, based on the audio recording data of the sales negotiation.
